(19) United States
(12) Patent Application Publication
(10) Pub. No.: US 2026/0277091 A1
(43) Pub. Date: Sep. 17, 2026

(54) STRETCHING APPARATUS

(71) Applicant: DENSO TEN Limited, Kobe (JP)

(72) Inventor: Atsushi TSUNODA, Kobe (JP)

(73) Assignee: DENSO TEN Limited, Kobe (JP)

(21) Appl. No.: 19/325,107

(22) Filed: Sep. 10, 2025

(30) Foreign Application Priority Data
Mar. 13, 2025 (JP) 2025-040708

(51) Int. Cl. G03B 21/58

(52) U.S. Cl. CPC G03B 21/58

(57) ABSTRACT

A stretching apparatus includes: a planar body changing between a stretched state of being drawn out and planarly stretched and a storage state of being wound, and a pantograph mechanism being disposed on a back side of the planar body, expanded in the stretched state of the planar body and folded in the storage state of the planar body. The pantograph mechanism includes a set of first arms, a set of second arms rotatably connected to the set of first arms on a side of a drawing direction of the planar body and supporting an edge of the planar body in the drawing direction. At least one of the set of first arms and the set of second arms has a set of partial arms, and a rotation mechanism rotatably connecting the set of partial arms via a rotation shaft parallel to the planar body in the stretched state.

### BACKGROUND OF THE INVENTION

### Field of the Invention

The invention relates to a stretching apparatus of a planar body.

### Description of the Background Art

There has been known a flexible display with flexibility using a film OLED (organic light-emitting diode), and the like. The film OLED is, for example, obtained by forming a light emitting element, such as an organic EL (Electro Luminescence), on a flexible film substrate. Since the flexible display has flexibility, for example, when not in use, the flexible display is wound and stored in a housing (storage case), and when using (viewing), the flexible display is drawn out from the housing and planarly stretched.

A pantograph mechanism for stretching when using a screen that is wound in a roll shape and stored has been known (for example, refer to the Japanese Published Unexamined Patent Application No.2008-286901 (Patent Document 1)). According to the technology disclosed in the Patent Document 1, a planar body, such as a screen, is stretched in a vertical direction by the pantograph mechanism.

When a user, and the like, come into contact with the stretching apparatus of stretching the planar body, since the mechanism of expanding the planar body generally has relatively high rigidity, the user may receive a large impact.

### SUMMARY OF THE INVENTION

According to one aspect of the invention, a stretching apparatus includes: a planar body changing between a stretched state of being drawn out and planarly stretched and a storage state of being wound, and a pantograph mechanism being disposed on a back side of the planar body, expanded in the stretched state of the planar body and folded in the storage state of the planar body. The pantograph mechanism includes a set of first arms, a set of second arms rotatably connected to the set of first arms on a side of a drawing direction of the planar body and supporting an edge of the planar body in the drawing direction. At least one of the set of first arms and the set of second arms has a set of partial arms, and a rotation mechanism rotatably connecting the set of partial arms via a rotation shaft parallel to the planar body in the stretched state.

It is an object of the invention to provide a technology for mitigating an impact at the time of contact in the stretching apparatus of stretching the planar body.

These and other objects, features, aspects and advantages of the invention will become more apparent from the following detailed description of the invention when taken in conjunction with the accompanying drawings.

### BRIEF DESCRIPTION OF THE DRAWINGS

FIG. 1 is a perspective view viewed from a back side of a stretching apparatus in a stretched state;

FIG. 2 is a back view of the stretching apparatus in the stretched state;

FIG. 3 is a back view of the stretching apparatus in a storage state;

FIG. 4 is a partial exploded perspective view of a first arm;

FIG. 5A illustrates an example of a vicinity of a rotation mechanism of the first arm;

FIG. 5B illustrates an example of the vicinity of the rotation mechanism of the first arm;

FIG. 6A illustrates deformation of the vicinity of the rotation mechanism of the first arm;

FIG. 6B illustrates the deformation of the vicinity of the rotation mechanism of the first arm;

FIG. 7 illustrates deformation of the stretching apparatus;

FIG. 8 is a back view of a stretching apparatus in a stretched state according to a modification example;

FIG. 9A is a cross-sectional view of a vicinity of a rotation mechanism showing one example of a cross section along the line A-A in FIG. 8; and

FIG. 9B is a cross-sectional view of the vicinity of the rotation mechanism showing one example of the cross section along the line A-A in FIG. 8.

### DESCRIPTION OF THE EMBODIMENTS

Hereinafter, an embodiment of the invention will be described with reference to the accompanying drawings. Configurations and their combinations in the embodiment are one example, and configurations may be added, omitted, replaced, and modified into other forms in the scope not departing from the spirit of the invention.

### Embodiment

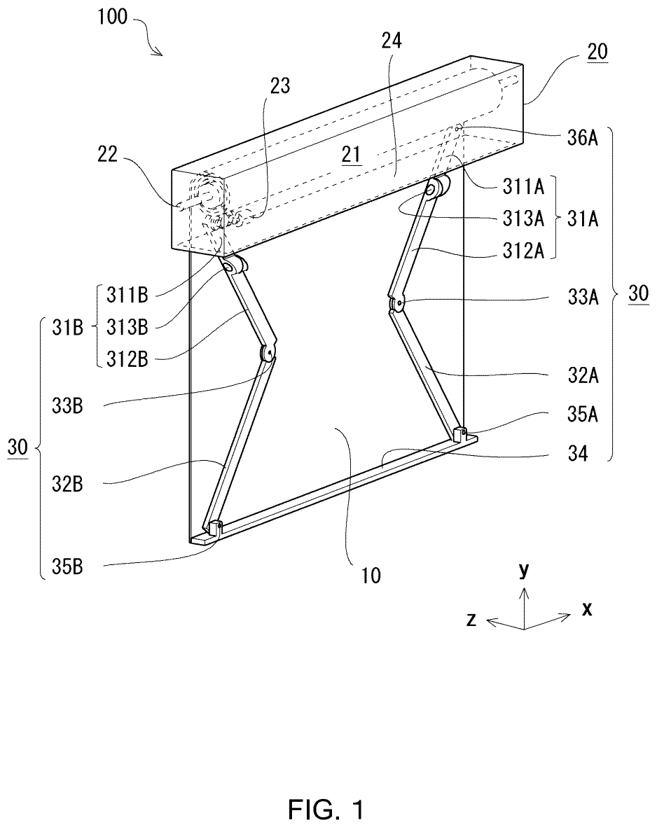

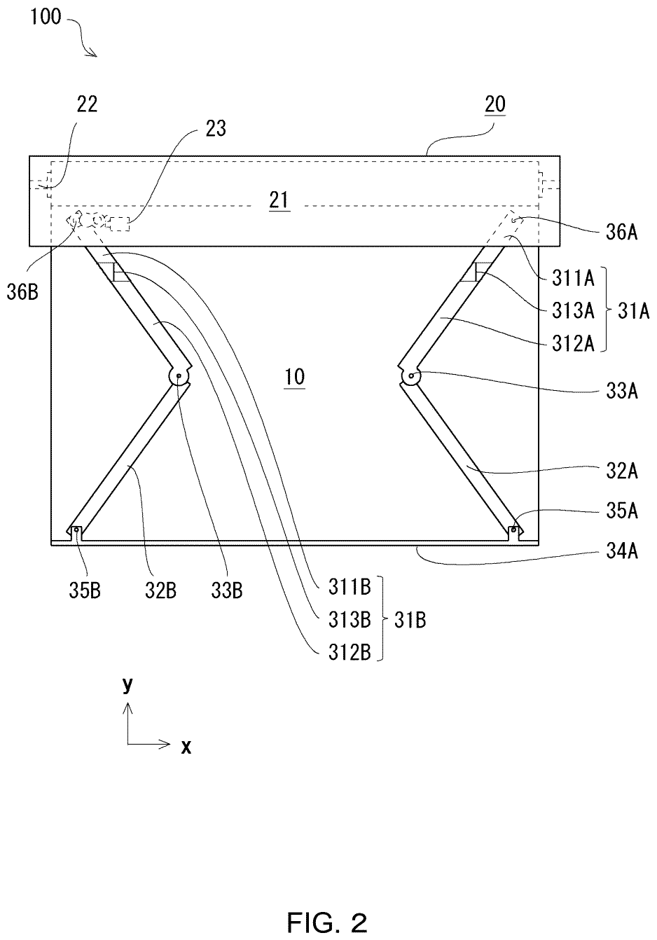

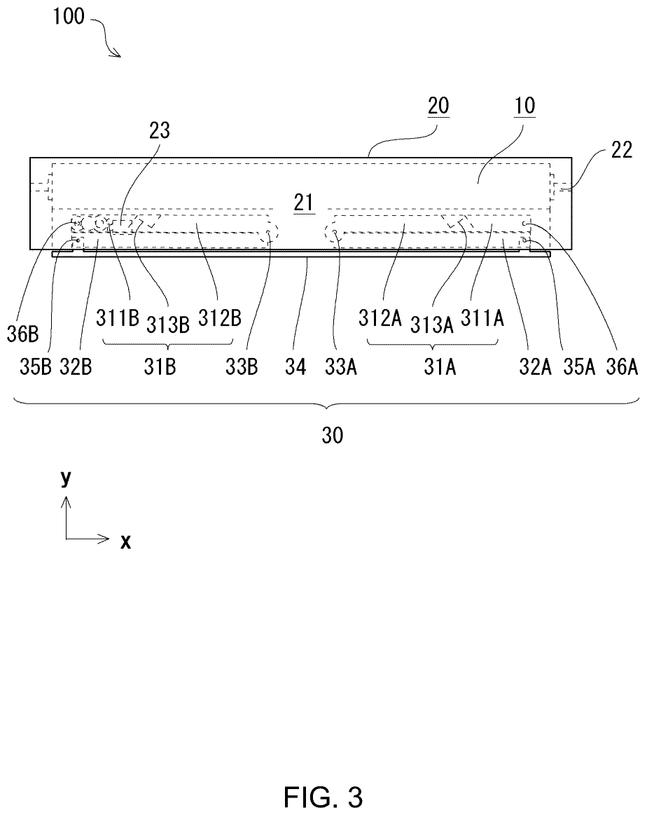

FIG. 1 is a perspective view viewed from a back side of a stretching apparatus 100 in a stretched state. FIG. 2 is a back view of the stretching apparatus 100 in a stretched state. FIG. 3 is a back view of the stretching apparatus 100 in a storage state. In the stretching apparatus 100 according to this embodiment, for example, when using a planar body 10, the planar body 10 is drawn out from a housing (storage case) 20 and stretched. The stretching apparatus 100 also has a function as a storage apparatus. In the stretching apparatus 100, for example, when not using the planar body 10, the planar body 10 is drawn into (wound) and stored in the housing 20.

The planar body 10 stretched by the stretching apparatus 100 is, for example, a flexible sheet. The kind and usage of the planar body are particularly not limited. However, a flexible display having flexibility (softness) using a film OLED (Organic Light-Emitting Diode), and the like, will be described here as an example. For example, the film OLED has a structure in which a light emitting element, such as an organic EL (Electro Luminescence), is formed on a flexible film substrate. In this case, the stretching apparatus 100 is used as a display apparatus, a DA (Display Audio) product, and the like. The planar body 10 may be a screen for projecting a video by a projector, a screen for notices, a shutter for dividing a space, or the like. The stretching apparatus 100 according to this embodiment is preferably used, for example, as an in-vehicle display apparatus to be mounted in a cabin of an automobile.

In the stretching apparatus 100, the planar body 10 is stored in the housing 20 when not using the planar body 10. In the stretching apparatus 100, the planar body 10 is drawn out from the housing 20 and planarly stretched when using (viewing). Each of FIG. 1 and FIG. 2 illustrates the “stretched state” that means that the planar body 10 is drawn out from the housing 20 and planarly stretched. FIG. 3 illustrates the “storage state” that means that the planar body 10 is stored in the housing 20.

The planar body 10 has a rectangular plane in the stretched state. As shown by arrows in FIG. 1 and other figures, when the planar body 10 is viewed from a front side (viewing surface), a horizontal direction is referred to as a “width direction” (x direction), and a vertical direction is referred to as an “up and down direction” (y direction). A “thickness direction” (z direction) of the planar body 10 is orthogonal to the width direction (x direction) and the up and down direction (y direction). For convenience of illustration, when the planar body 10 is viewed from a back side, in the width direction (x direction), a right direction is referred to as a positive x-axis direction, in the up and down direction (y direction), an upward direction is referred to as a positive y-axis direction, and in the thickness direction (z direction), a front direction of the planar body 10 is referred to as a positive z-axis direction.

The housing 20 is a storage case that stores the planar body 10 when not using the planar body 10 (e.g., when not viewing). The housing 20 is, for example, provided on a ceiling of a cabin of a vehicle. The housing 20 may be formed integrally with an interior panel of the ceiling of the vehicle. A housing space (storage space) 21 of the planar body 10 is formed inside the housing 20. The planar body 10, and various devices, members, and the like, to draw the planar body 10 out from the housing 20 or draw the planar body 10 into the housing 20 are provided inside the housing 20.

Specifically, a roller pipe 22 for winding the planar body 10, a rotary dumper 23 for adjusting a winding speed, and a pantograph mechanism 30 to support the planar body 10, and the like, are provided inside the housing 20. A driver to expand or fold the pantograph mechanism 30 may be further provided inside the housing 20.

An opening 24 is provided in a lower surface of the housing 20. The opening 24 is an inlet/outlet for taking in and out the planar body 10 from the housing 20. The opening 24 has a size large enough not to interfere with the pantograph mechanism 30.

The pantograph mechanism 30 includes first arms 31 (31A, 31B), second arms 32 (32A, 32B), first supporting pins (pivot pin) 33 (33A, 33B), a support plate 34, second supporting pins 35 (35A, 35B), and third supporting pins 36 (36A, 36B). The first arms 31, the second arms 32, the first supporting pins 33, the second supporting pins 35, and the third supporting pins 36 are provided in pairs, respectively. The support plate 34 is a reinforcing frame connected to an edge of the planar body 10 in a drawing direction (negative y-axis direction). The pantograph mechanism 30 is mainly formed of metal, resin, and the like, and particularly preferably formed of a relatively lightweight and rigid material.

The first arms 31 and the second arms 32 are columnar link members mainly constituting the pantograph mechanism 30. One end of each of the first arms 31 is rotatably connected to the housing 20 via each of the third supporting pins 36. A pivot (pivot shaft) of each of the third supporting pin 36 extends in a perpendicular direction (z direction) to the planar body 10 in the stretched state. In other words, the one end of each of the first arms 31 rotates around a rotation shaft (each of the third supporting pins 36) that extends in the z direction with respect to the housing 20. The other end of each of the first arms 31 is rotatably connected to one end of each of the second arms 32 via each of the first supporting pins 33. A pivot of each of the first supporting pins 33 to be provided in each of the first arms 31 and each of the second arms 32 also extends in the z direction. In other words, the one end of each of the second arms 32 rotates around a rotation shaft (each of the first supporting pins 33) that extends in the z direction with respect to the other end of each of the first arms 31. The other end of each of the second arms 32 is rotatably connected to the support plate 34 via each of the second supporting pins 35. A pivot of each of the second supporting pins 35 to be provided in each of the second arms 32 and the support plate 34 also extends in the z direction. In other words, the other end of each of the second arms 32 rotates around a rotation shaft (each of the second supporting pins 35) that extends in the z direction with respect to the support plate. Through such a configuration, when the pantograph mechanism 30 is expanded and folded, the pantograph mechanism 30 is deformed in a plane (xy plane) parallel to the planar body 10 in the stretched state.

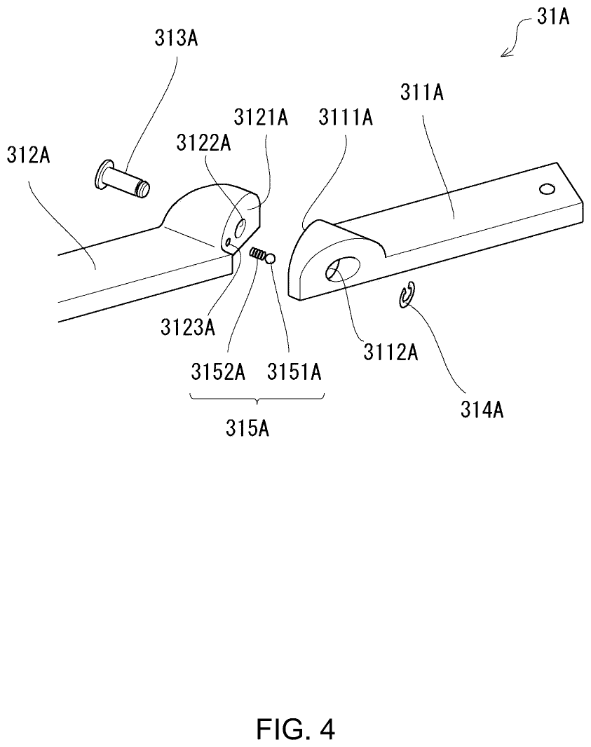

The first arms 31 include first partial arms 311 (311A, 311B), second partial arms 312 (312A, 312B), and fourth supporting pins 313, respectively. FIG. 4 is a partial exploded perspective view of each of the first arms 31. In the stretched state of the planar body 10, the first partial arm 311A has a connection surface 3111A perpendicular to the planar body 10 and extending in a vertical direction. That is, the connection surface 3111A is positioned parallel to an yz plane in the stretched state of the planar body 10. Similarly, in the stretched state of the planar body 10, the second partial arm 312 has a connection surface 3121A perpendicular to the planar body 10 and extending in the vertical direction. The connection surface 3121A is also positioned parallel to the yz plane in the stretched state of the planar body 10. The first partial arm 311A has a through hole 3112A that is counterbored and the through hole 3112A extends in a perpendicular direction to the connection surface 3111A. Similarly, the second partial arm 312A has a through hole 3122A that is counterbored and the through hole 3122A extends in a perpendicular direction to the connection surface 3121A. The fourth supporting pin 313A is inserted into the through hole 3112A, and the through hole 3122A, and rotatably connects the first partial arm 311A and the second partial arm 312A. Each of the fourth supporting pins 313A, the through hole 3112A, and the through hole 3122A are a “rotation mechanism” according to this embodiment. A stopper 314A is connected to an end of each of the fourth supporting pins 313A. The stopper 314A is, for example, an E-ring.

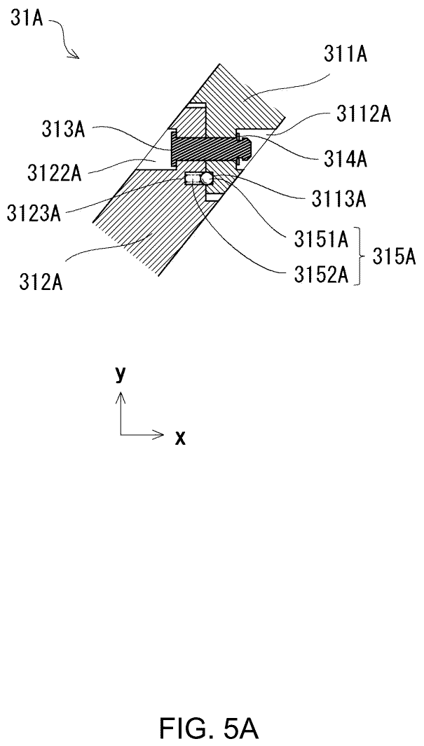

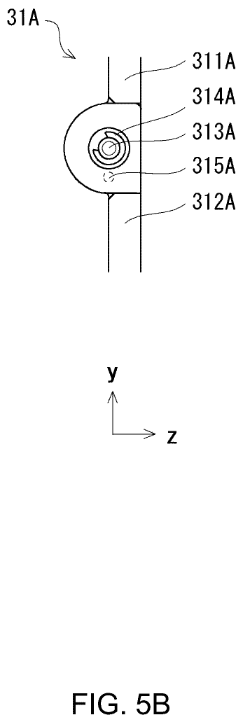

The second partial arm 312A has a non-through hole 3123A extending in a perpendicular direction to the connection surface 3121A. A ball plunger (positioning pin) 315A including a ball 3151A and a compression spring 3152A is provided inside the non-through hole 3123A. Each of FIG. 5A and FIG. 5B illustrates an example of a vicinity of the rotation mechanism of each of the first arms 31. FIG. 5A is a cross-sectional view of the vicinity of the rotation mechanism. Specifically, FIG. 5A illustrates a cross section cutting the first arm 31A in the xy plane passing through each of the fourth supporting pins 313A and the ball plunger 315A. FIG. 5B is a side view of the vicinity of the rotation mechanism viewed from the positive x-axis direction. In each of the first partial arms 311A, a recess 3113A is provided in a position facing the non-through hole 3123A of each of the second partial arm 312A, and receives the ball 3151A of the ball plunger 315A. On the other hand, the ball plunger 315A energizes the ball 3151A to a side of the first partial arm 311A. The ball plunger 315A is an “engagement member” according to this embodiment. The first arms 31A is kept in a straight line by the engagement member.

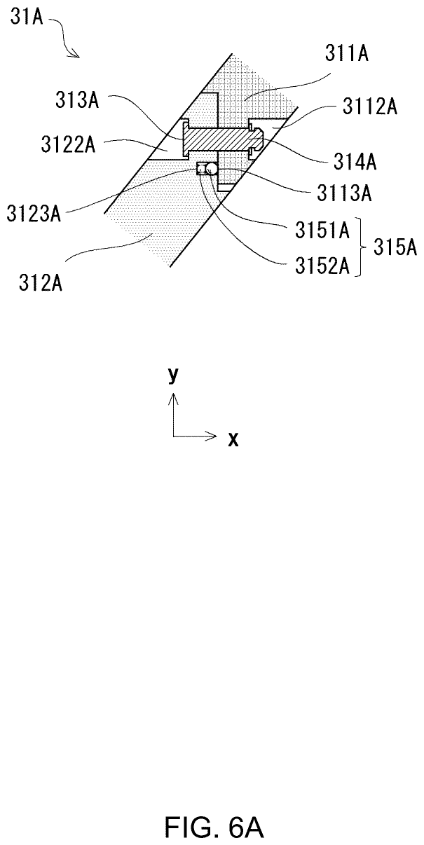

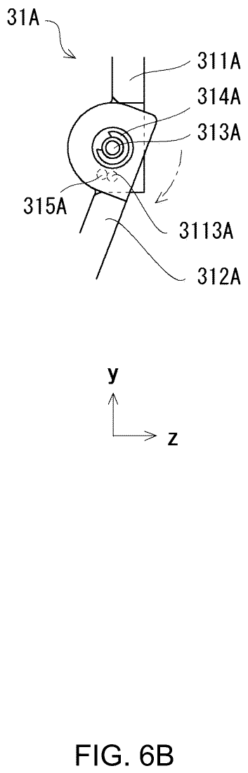

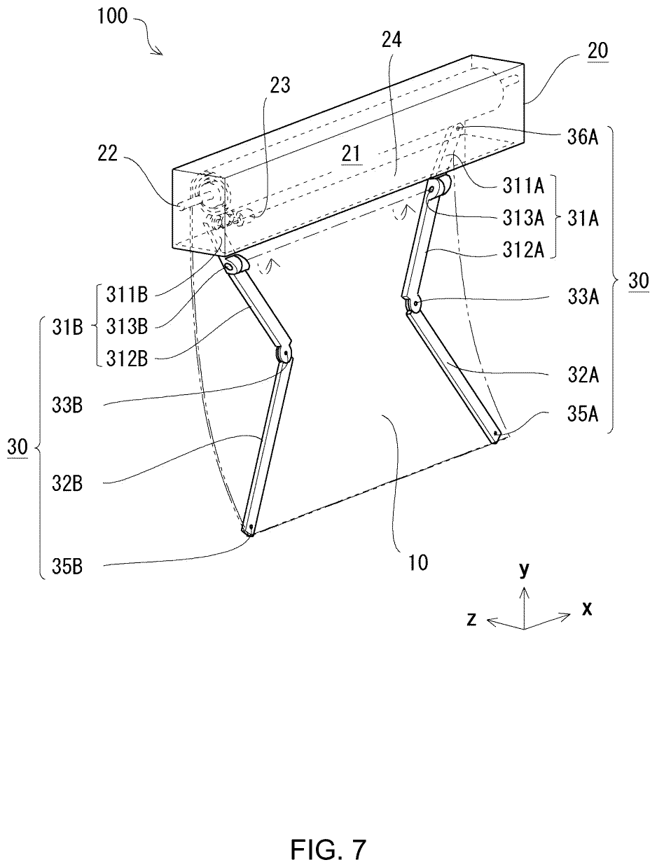

Each of FIG. 6A FIG. 6B illustrates deformation of the vicinity of the rotation mechanism of each of the first arms 31 when a lower part of the planar body 10 receives an impact. FIG. 6A illustrates a cross section cutting the first arms 31A in the xy plane as in FIG. 5A. FIG. 6B is a side view of the vicinity of the rotation mechanism viewed from the positive x-axis direction. FIG. 7 illustrates deformation of the stretching apparatus 100 when the lower part of the planar body 10 receives the impact. When the planar body 10 and the pantograph mechanism 30 (particularly, the second arm 32A and the second partial arm 312A) receive a load that has a directional component in a perpendicular direction (z direction) to the planar body 10 and is equal to or larger than a specified reference value, an engagement between the ball plunger 315A and the recess 3113A is canceled, and the second partial arm rotates around each of the fourth supporting pins 313A as a rotation shaft with respect to the first partial arm (hereinafter, such an action is referred to as “the rotation mechanism rotates”). In FIG. 6B, a rotation direction is indicated by an arrow of a dashed-dotted line. In FIG. 7, a rotation shaft is indicated by a dashed-dotted line, and a rotation direction is indicated by a broken line. The first arm 31A illustrated in FIG. 4 to FIG. 6 (FIG. 6A and FIG. 6B) and the first arm 31B have a bilaterally symmetrical structure and are deformed in a similar manner. Therefore, as illustrated in FIG. 6 and FIG. 7, the rotation mechanism rotates to release the impact. As a result, it is possible to mitigate the impact when coming into contact with the stretching apparatus 100.

Since the first partial arm and the second partial arm are rotatably connected by the above rotation mechanism, it is possible to realize the pantograph mechanism that mitigates the impact by rotating when the planar body receives a load. Such a pantograph mechanism provides a technology for mitigating the impact at the time of contact in the stretching apparatus of stretching the planar body.

### Modification Example

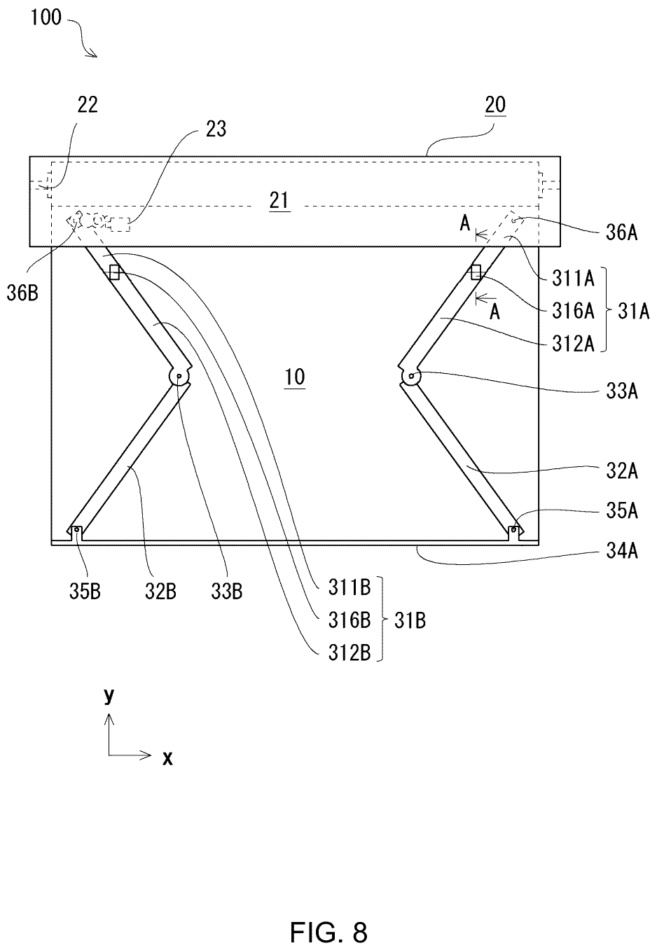

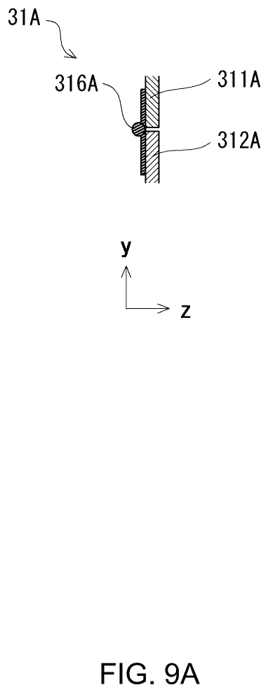

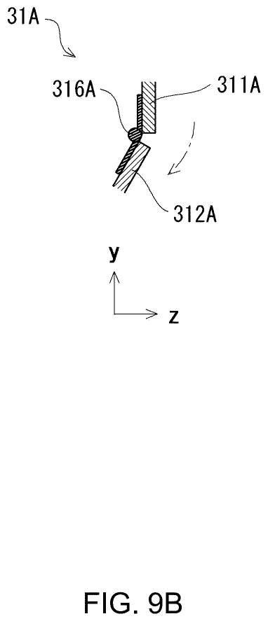

The rotation mechanism described in the embodiment is one example. The rotation mechanism may be, for example, a hinge that connects the first partial arm 311 and the second partial arm 312. FIG. 8 is a back view of a stretching apparatus 100 in a stretched state according to a modification example. Each of FIG. 9A and FIG. 9B is a cross-sectional view of a vicinity of a rotation mechanism showing one example of a cross section along the line A-A in FIG. 8. FIG. 9A is a cross-sectional view of the vicinity of the rotation mechanism in normal use. FIG. 9B is a cross-sectional view for illustrating deformation when a lower part of a planar body 10 receives an impact. In the modification example, constituent elements corresponding to those in the embodiment are denoted by the same numerals and a description thereof is omitted.

A first arm 31 according to the modification example also includes a first partial arm 311 and a second partial arm 312. However, a connection surface of each of the first partial arm 311 and the second partial arm 312 is horizontal in the stretched state of the planar body 10. In the rotation mechanism, a hinge 316 is provided on a back side of each of the first partial arm 311 and the second partial arm 312. The first partial arm 311 and the second partial arm 312 are rotatably connected each other by the hinge 316. Since the hinge 316 is rotated, a tip of the second partial arm 312 may be displaced in a backward direction. In FIG. 9B, a rotation direction is indicated by an arrow of a dashed-dotted line. In this way, the rotation mechanism according to the modification example rotates to release the impact. As a result, it is possible to mitigate the impact when coming into contact with the stretching apparatus 100. Compared to this modification example, as in the embodiment described above, since the rotation shaft is provided in the arms (the first partial arm 311 and the second partial arm 312), it is possible to prevent the pantograph mechanism 30 from enlarging.

The rotation mechanism according to the modification example may have, for example, an energizing member, such as a torsion spring. According to such an energizing member, since the first partial arm 311 and the second partial arm 312 are energized to be positioned in a straight line, a shape of the pantograph mechanism 30 is kept so that the planar body 10 is planarly stretched in normal use. When receiving a load exceeding energizing force of the energizing member, the energizing member is elastically deformed, and the rotation mechanism rotates.

Although the embodiment and the modification example have been described above, the above-described embodiment and modification may be combined. Various changes or modifications may be added without departing from the scope of the invention.

For example, the pantograph mechanism 30 is not limited to a structure in which the pantograph mechanism 30 is bent toward an inner side of the stretching apparatus 100 as illustrated. The pantograph mechanism 30 may have a structure in which the link members are connected to form a diamond shape in a back view of the stretching apparatus 100. The pantograph mechanism 30 may have a structure in which not only the first arm 31 and the second arm 32, but also a third arm, and the like, is connected. The pantograph mechanism 30 in which the first arms 31, the second arms 32, and the like, are provided in pairs (as a set) has been exemplified. However, three or more of the first arms 31, the second arms 32, and the like, may be provided as a set.

In the stretching apparatus 100, a structure has been described in which the planar body 10 is drawable from vertically upward to vertically downward. However, the planar body 10 may be drawable from vertically downward to vertically upward. In such a way, according to the rotation mechanism, it is possible to mitigate the impact when coming into contact with the stretching apparatus 100.

In the rotation mechanism, a structure has been described in which a plurality of the rotation shafts is disposed to be positioned in a straight line extending horizontally in the stretched state of the planar body 10. However, when the plurality of the rotation shafts is disposed to be positioned not only horizontally but also in a straight line, the rotation mechanism rotates to release the impact. The rotation mechanism may be provided not only to the first arm 31 but also to the second arm 32 and other link members. Although a set of (a pair of) the rotation mechanisms has been exemplified, the pantograph mechanism 30 may include two sets or more of the rotation mechanisms.

While the invention has been shown and described in detail, the foregoing description is in all aspects illustrative and not restrictive. It is therefore understood that numerous other modifications and variations can be devised without departing from the scope of the invention.

What is claimed is:

1. A stretching apparatus comprising:
a planar body configured to take either a stretched state of being drawn out in a drawing direction to be planarly stretched or a storage state of being wound;
a pantograph mechanism being disposed on a back side of the planar body, expanded in the stretched state of the planar body, and folded in the storage state of the planar body, the pantograph mechanism including a set of first arms, and a set of second arms rotatably connected to the set of first arms on a side of the drawing direction of the planar body, the set of second arms supporting an edge of the planar body in the drawing direction, at least one of the set of first arms and the set of second arms having a set of partial arms; and
at least one rotation mechanism rotatably connecting the set of partial arms via a rotation shaft parallel to the planar body in the stretched state.

2. A stretching apparatus according to claim 1, wherein
the at least one rotation mechanism includes a set of rotation mechanisms, and
the rotation shaft of each of the set of rotation mechanism included in the set of first arms or the set of second arms is disposed on a same straight line.

3. A stretching apparatus according to claim 2, wherein
the rotation shaft of each of the set of rotation mechanisms is disposed on the same straight line extending horizontally.

4. A stretching apparatus according to claim 1, wherein
each of the set of partial arms has a connection surface being connected to each other,
the connection surface is perpendicular to the planar body and is a vertical plane in the stretched state of the planar body, and
the rotation shaft is disposed perpendicular to the connection surface.

5. A stretching apparatus according to claim 4, wherein
one of the set of partial arms has, in the connection surface thereof, an engagement member being engaged with the connection surface of the other of the set of partial arms when each of the set of partial arms is positioned in a plane parallel to the planar body in the stretched state.

6. A stretching apparatus according to claim 5, wherein
the engagement member is a ball plunger, and
the connection surface of the other of the set of partial arms has a recess being engaged with the ball plunger.

7. A stretching apparatus according to claim 6, wherein
when the planar body in the stretched state receives a load having a directional component perpendicular to the planar body, an engagement between the ball plunger and the recess is canceled, and the at least one rotation mechanism rotates.

8. A stretching apparatus according to claim 1, wherein
the at least one rotation mechanism is a hinge connecting each of the set of partial arms.

9. A stretching apparatus according to claim 8, wherein
the at least one rotation mechanism has an energizing member by which each of the set of partial arms is energized so that each of the set of partial arms is positioned in a plane parallel to the planar body in the stretched state.

10. A stretching apparatus according to claim 9, wherein
the energizing member is a torsion spring, and
when the planar body in the stretched state receives a load that is larger than energizing force of the torsion spring and that has a directional component perpendicular to the planar body in the stretched state, the torsion spring is elastically deformed, and the rotation mechanism rotates.
